(19) United States
(12) Patent Application Publication
(10) Pub. No.: US 2009/0121184 A1
(43) Pub. Date: May 14, 2009

(54) Hydrogen storage material and method for manufacturing same

(76) Inventor: Hironobu Fujii, Higashi-Hiroshima-shi, Hiroshima (JP)

Correspondence Address: BIRCH STEWART KOLASCH & BIRCH, PO BOX 747, FALLS CHURCH, VA, 22040-0747, US

(21) Appl. No.: 11/887,080

(22) PCT Filed: Mar. 27, 2006
(86) PCT No.: PCT/JP2006/306103

§ 371 Date: Sep. 25, 2007

(30) Foreign Application Priority Data
Mar. 28, 2005 (JP) 2005-092362
Apr. 28, 2005 (JP) 2005-132573

(51) Int. Cl. C09K 3/00

(52) U.S. Cl. 252/188.25

(57) ABSTRACT

[Problem] To provide a hydrogen storage material which decreases the hydrogen release start temperature and the hydrogen release peak temperature, and to provide a method for manufacturing thereof.

[Solution] Provided is a hydrogen storage material which contains: a mixture and a reaction product of lithium hydride and magnesium amide, wherein the lithium hydride and the magnesium amide are prepared by combining as the raw materials: one or more substance selected from the group consisting of an amide compound, an imide compound, and a nitride of magnesium, and an amide compound, an imide compound, and a nitride of lithium; and one or more substance selected from the group consisting of an amide compound, an imide compound, a nitride, a hydride, and a metal of magnesium, and an amide compound, an imide compound, a nitride, a hydride, and a metal of lithium, with the raw materials contains both magnesium and lithium metallic species.

### TECHNICAL FIELD

The present invention relates to a hydrogen storage material which generates hydrogen for fuel of fuel cells and the like, and to a method for manufacturing thereof.

### BACKGROUND ART

There are extensive development works of fuel cells as a clean energy source which does not generate hazardous substances such as NOx and SOx and does not generate greenhouse gases such as CO₂. The fuel cells have already been brought into practical use in several fields. The technology to store hydrogen as the fuel of fuel cells is an important technology to support the fuel cell technology. Known types of hydrogen storage include the compression storage in pressure cylinder, cryogenic storage in a form of liquefied hydrogen, and storage using a hydrogen storage substance.

As of these hydrogen storage types, the storage using a hydrogen storage substance is advantageous in terms of distributed storage and of transportation. Preferable hydrogen storage substances are materials having high hydrogen storage efficiency, that is, the one having large quantity of stored hydrogen per unit weight or unit volume of the hydrogen storage substance, and the one being capable of absorbing and releasing hydrogen at low temperatures, further the one having good durability.

Known hydrogen storage substances include metallic materials centering on rare-earth-based ones, titanium-based ones, vanadium-based ones, and magnesium-based ones, and light-weight inorganic compounds such as metal alanate (for example, NaAlH₄ and LiAlH₄), and carbon. Other than those, there is reported a hydrogen storage method using a lithium nitride represented by the following formula (1), (for example, refer to Non-Patent Documents 1 and 2).

Li₃N+2H₂=Li₂NH+LiH+H₂=LiNH₂+2LiH (1)

In the reaction, the absorption of hydrogen by Li₃N begins at about 100° C., and there was confirmed the hydrogen absorption of 9.3% by mass at 255° C. after 30 min. Two steps of 6.3% by mass at slightly below 200° C. and 3.0% by mass at 320° C. or higher temperatures under a slow heating condition is reported for the characteristic of releasing absorbed hydrogen. That is, the reaction of the formula (2), corresponding to the right side of the formula (1), begins at slightly below 200° C., and the reaction of the formula (3), corresponding to the left side of the formula (1), begins at about 320° C.

LiNH₂+2LiH→Li₂NH+LiH+H₂↑ (2)

Li₂NH+LiH→Li₃N+H₂↑ (3)

The lithium nitride given in the formula (1) has, however, problems of high hydrogen release start temperature and high hydrogen release peak temperature.

### Non-Patent Document 1: Ruff, O., and Goerges, H., Berichte der Deutschen Chemischen Gesellschaft zu Berlin, Vol. 44, 502-6 (1911)

Non-Patent Document 2: Ping Chen et al., Interaction of hydrogen with metalnitrides and imides, NATURE Vol. 420, 21 NOVEMBER 2002, p. 302-304

### DISCLOSURE OF THE INVENTION

### Problems to be Solved by the Invention

The present invention achieved with the view of such circumstances, and aims to provide a hydrogen storage material having low hydrogen release start temperature and low hydrogen release peak temperature, and a method for manufacturing the hydrogen storage material.

### Means to Solve the Problems

According to the present invention, there is provided a hydrogen storage material which contains: a mixture and a reaction product of lithium hydride and magnesium amide, wherein the lithium hydride and the magnesium amide are prepared by combining as the raw materials: one or more substance selected from the group consisting of an amide compound, an imide compound, and a nitride of magnesium, and an amide compound, an imide compound, and a nitride of lithium; and one or more substance selected from the group consisting of an amide compound, an imide compound, a nitride, a hydride, and a metal of magnesium, and an amide compound, an imide compound, a nitride, a hydride, and a metal of lithium, with the raw materials containing both the magnesium and lithium metallic species. The hydrogen storage material according to the present invention shows a significant effect on the manufacturing process.

According to the present invention, there is also provided a hydrogen storage material containing: a mixture and a reaction product of lithium hydride and magnesium amide, wherein the lithium hydride and the magnesium amide in the hydrogen storage material are prepared by using magnesium nitride and lithium amide as the raw materials. The hydrogen storage material according to the present invention shows a significant effect on the manufacturing process.

According to the present invention, there is provided a hydrogen storage material containing: a mixture and a reaction product of lithium hydride and magnesium amide, wherein the lithium hydride and the magnesium amide in the hydrogen storage material are prepared by using magnesium metal and lithium amide as the raw materials. According to the present invention, there is provided a hydrogen storage material being further added one or more substance selected from the group consisting of lithium hydride and magnesium hydride as the raw materials. The hydrogen storage material according to the present invention shows a significant effect on the manufacturing process.

According to the present invention, there is provided a hydrogen storage material comprising: a mixture and a reaction product of lithium hydride and magnesium amide, wherein the lithium hydride and the magnesium amide in the hydrogen storage material are prepared by using lithium metal and magnesium metal as the raw materials, and further using one or more substance selected from the group consisting of lithium amide and magnesium amide as the raw materials. The hydrogen storage material according to the present invention shows a significant effect on the manufacturing process.

In the hydrogen storage material, the mixing ratio of lithium hydride is preferably in a range from 1.5 to 4 moles per 1 mole of magnesium amide.

The hydrogen storage material preferably further contains a catalyst for enhancing the hydrogen absorbing and releasing performance. A compound or hydrogen storage alloy, containing one or more element selected from the group consisting of B, C, Mn, Fe, Co, Ni, Pt, Pd, Rh, Na, Mg, K, Ir, Nb, Nd, La, Ca, V, Ti, Cr, Cu, Zn, Al, Si, Ru, Mo, Ta, Zr, Hf, and Ag is preferably used for the catalyst. The catalyst is further preferably one or more chloride, oxide, or metal, containing an element selected from the group consisting of Nb, Nd, V, Ti, and Cr.

In the hydrogen storage material according to the present invention, the mixture and the reaction product are preferably structured and arranged at nano-scale by mechanical milling.

According to the present invention, there is provided a method for manufacturing above hydrogen storage material. That is, there is provided a method for manufacturing hydrogen storage material, having the step of mixing a metal amide compound containing metal of lithium and metal of magnesium as the components with one or more compound or metal selected from the group consisting of a metal hydride, a metal nitride, a metal imide compound, and a metal, in an atmosphere of inert gas, hydrogen gas, or a mixture of inert gas and hydrogen gas.

According to the present invention, there is provided a method for manufacturing hydrogen storage material, having the step of supporting a catalyst through any of catalyst-supporting steps of: further adding a catalytic substance with hydrogen absorbing and releasing performance in the mixing step, thus supporting the catalytic substance on a treating material; mixing a catalytic substance for enhancing the hydrogen absorbing and releasing performance with the treated material obtained by the mixing step, thus supporting the catalytic substance on the treating material; and supporting a catalytic substance for enhancing the hydrogen absorbing and releasing performance on at least one of the metal hydride and the metal amide compound before the mixing step.

In the method for manufacturing hydrogen storage material, the gas pressure in the mixing step is preferably atmospheric pressure or above. As described before, one or more compound or hydrogen storage alloy, containing an element selected from the group consisting of B, C, Mn, Fe, Co, Ni, Pt, Pd, Rh, Na, Mg, K, Ir, Nb, Nd, La, Ca, V, Ti, Cr, Cu, Zn, Al, Si, Ru, Mo, Ta, Zr, Hf, and Ag is preferably used for the catalytic substance is. The catalyst is further preferably one or more chloride, oxide, or metal, containing an element selected from the group consisting of Nb, Nd, V, Ti, and Cr.

According to the present invention, there is provided a method for manufacturing hydrogen storage material, in which the mixing step is followed by the step of heat treatment given in a vacuum.

Furthermore, there is provided a method for manufacturing hydrogen storage material, wherein the mixing step is followed by the step of heat treatment in an atmosphere of inert gas, hydrogen gas, or a mixture of inert gas and hydrogen gas.

In the method for manufacturing hydrogen storage material according to the present invention, it is preferable that lithium amide is used for the metal amide compound, and that magnesium nitride is used for one or more compound or metal selected from the group consisting of the metal hydride, the metal nitride, the metal imide compound, and the metal.

In the method for manufacturing hydrogen storage material according to the present invention, it is preferable that lithium amide is used for the metal amide compound, and that magnesium nitride and one or more compound selected from the group consisting of lithium hydride and magnesium hydride is used for one or more compound or metal selected from the group consisting of the metal hydride, the metal nitride, the metal imide compound, and the metal.

In the method for manufacturing hydrogen storage material according to the present invention, it is preferable that lithium amide is used for the metal amide compound, and that magnesium metal is used for one or more compound or metal selected from the group consisting of the metal hydride, the metal nitride, the metal imide compound, and the metal.

In the method for manufacturing hydrogen storage material according to the present invention, it is preferable that lithium amide is used for the metal amide compound, and that magnesium metal and one or more compound selected from the group consisting of lithium hydride and magnesium hydride are used for one or more compound or metal selected from the group consisting of the metal hydride, the metal nitride, the metal imide compound, and the metal.

In the method for manufacturing hydrogen storage material according to the present invention, it is preferable that lithium amide is used for the metal amide compound, and that magnesium metal and lithium metal, and one or more compound selected from the group consisting of lithium hydride and magnesium hydride are used for one or more compound or metal selected from the group consisting of the metal hydride, the metal nitride, the metal imide compound, and the metal.

### EFFECT OF THE INVENTION

The hydrogen storage material according to the present invention can decrease the hydrogen generation temperature and the hydrogen release peak temperature more than those in the related art.

### BRIEF DESCRIPTION OF THE DRAWINGS

FIG. 1 illustrates the relation between the temperature-rise and the hydrogen release intensity for the hydrogen storage material of Example 1, Example 2, Comparative Example 1, and Comparative Example 2.

FIG. 2 illustrates the X-ray diffraction pattern of the hydrogen storage material of Example 9.

FIG. 3 illustrates the X-ray diffraction pattern of the hydrogen storage material of Example 11.

FIG. 4 illustrates the X-ray diffraction pattern of the hydrogen storage material of Example 14.

FIG. 5 illustrates the X-ray diffraction pattern of the hydrogen storage material of Example 17.

FIG. 6 illustrates the relation between the temperature-rise and the hydrogen release intensity for the hydrogen storage material of Example 20.

### BEST MODES FOR CARRYING OUT THE INVENTION

The embodiments of the present invention will be described in the following.

The hydrogen storage material according to the present invention contains a mixture and a reaction product of metal hydride and metal amide compound. The metal species thereof are two kinds: lithium and magnesium. In concrete terms, there are cases: (1) the metal structuring the metal hydride is lithium, and the metal structuring the metal amide compound is magnesium; (2) the metal structuring the metal hydride is lithium, and the metal structuring the metal amide compound is magnesium and lithium; (3) the metal structuring the metal hydride is magnesium, and the metal structuring the metal amide compound is lithium; (4) the metal structuring the metal hydride is magnesium, and the metal structuring the metal amide compound is magnesium and lithium; and (5) the metal structuring the metal hydride is magnesium and lithium, and the metal structuring the metal amide compound is magnesium and/or lithium.

As an example, a preferable case is a combination that the metal hydride is lithium hydride (LiH), and that the metal amide compound contains magnesium amide (Mg(NH₂)₂) or a mixture of magnesium amide (Mg (NH₂)₂) with lithium amide (LiNH₂).

For the case of a material using lithium hydride (LiH) and magnesium amide (Mg (NH₂)₂), and when the mixing ratios thereof are adjusted to become equivalent with each other, the combination may be given to the formula (4). For the case of a material using magnesium hydride (MgH₂) and lithium amide (LiNH₂), the combination may be given to the formula (5). According to these combinations, the theoretical hydrogen storage percentage becomes 5.48% by mass.

2LiH+Mg(NH₂)₂ [symbol] Li₂NH+MgNH+2H₂ (4)

MgH₂+2LiNH₂ [symbol] Li₂NH+MgNH+2H₂ (5)

More preferably, for the case of a material using lithium hydride (LiH) and magnesium amide (Mg(NH₂)₂), it is preferable to adjust the quantity of lithium hydride to a range from 1.5 to 4 moles per 1 mole of magnesium amide, and more preferably to adjust to a range from 2.5 to 3.5 moles thereof per 1 mole of magnesium amide. As an example, the formula (6) shows the case that the lithium hydride is 2.67 moles per 1 mole of magnesium amide, (8LiH+3Mg(NH₂)₂). The theoretical hydrogen storage percentage at the combination of the formula (6) is 6.85% by mass, which gives higher hydrogen storage percentage than that of the case of formula (4).

8LiH+3Mg(NH₂)₂ [symbol] 4Li₂NH+Mg₃N₂+8H₂ (6)

Since magnesium amide is not available in the market, synthesis thereof is required. For example, the magnesium amide can be prepared by sealing a commercially available magnesium hydride and ammonia gas in a mill vessel, then by applying milling thereto for a certain period of time. Alternatively, magnesium amide can be synthesized by heating magnesium metal powder in a pressurized ammonia at approximately 300° C. to 350° C., or by bringing an ether solution of diethyl magnesium or iodized activated magnesium react with ammonia at 400° C.

The above synthesis methods, however, induce corrosion of the vessel by ammonia gas and need high temperature and high pressure reaction in ammonia gas, which hinders the industrial mass production in terms of manufacturing process. In this regard, the mass production of the hydrogen storage material according to the present invention is attained by using readily available magnesium hydride and lithium amide as the starting materials, by bringing them react together to form a hydrogen storage material which contains a mixture and a reaction product of lithium hydride and magnesium amide. For example, the reaction between magnesium hydride and lithium amide is conducted following the formula (7), in which the generated ammonia and hydrogen are removed, and then hydrogen is introduced into the system, thereby absorbing and releasing hydrogen in accordance with the formula (6) to provide the hydrogen storage material.

8LiNH₂+3MgH₂→4Li₂NH+Mg₃N₂+2NH₃↑+6H₂↑ (7)

Alternatively, the hydrogen storage material which absorbs and releases hydrogen in accordance with the formula (6) can be prepared by bringing magnesium hydride and lithium amide, and a hydride of lithium or magnesium, or metal of lithium or magnesium, react together, then by introducing hydrogen into the system. By adding magnesium hydride and lithium amide, and hydride of lithium or magnesium, or metal of lithium or magnesium, to the reaction system of the formula (7), the release of generated ammonia outside the system can be suppressed without affecting the composition of the target substance. As a result, the load to the industrial apparatuses is decreased to decrease the investment in the apparatuses, through which the synthesis can be conducted at an industrially advantageous position.

Similar to above, the hydrogen storage material which absorbs and releases hydrogen in accordance with the reaction of the formula (6) can be prepared by bringing readily available magnesium nitride and lithium amide react together as the starting materials by the reaction of the formula (8) to remove the generated ammonia, then by introducing hydrogen into the system.

Mg₃N₂+8LiNH₂→4Li₂NH+Mg₃N₂+4NH₃ (8)

Furthermore, the hydrogen storage material which absorbs and releases hydrogen in accordance with the reaction of the formula (6) can be prepared by bringing magnesium nitride and lithium amide, and hydride of lithium or magnesium, or metal of lithium or magnesium, react together, then by introducing hydrogen into the system. As described above, by adding magnesium hydride and lithium amide, and hydride of lithium or magnesium, or metal of lithium or magnesium, to the system of the formula (8), the release of generated ammonia outside the system can be suppressed without affecting the composition of the target substance. As a result, the load to the industrial apparatuses is decreased to decrease the investment in the apparatuses, through which the synthesis can be conducted at an industrially advantageous position.

Similar to above, the hydrogen storage material which absorbs and releases hydrogen in accordance with the reaction of the formula (6) can be prepared by bringing readily available lithium nitride and magnesium amide react together as the starting materials by the reaction of the formula (9) to remove the generated ammonia, then by introducing hydrogen into the system.

8Li₃N+9Mg(NH₂)₂→12Li₂NH+3Mg₃N₂+8NH₃ (9)

Furthermore, the hydrogen storage material which absorbs and releases hydrogen in accordance with the reaction of the formula (6) can be prepared by bringing lithium nitride and magnesium amide, and hydride of lithium or magnesium, or metal of lithium or magnesium, react together, then by introducing hydrogen into the system. As described above, by adding magnesium hydride and lithium amide, and hydride of lithium or magnesium, or metal of lithium or magnesium, to the system of the formula (9), the release of generated ammonia outside the system can be suppressed without affecting the composition of the target substance. As a result, the load to the industrial apparatuses is decreased to decrease the investment in the apparatuses, through which the synthesis can be conducted at an industrially advantageous position.

Similar to above, the hydrogen storage material which absorbs and releases hydrogen in accordance with the reaction of the formula (6) can be prepared by bringing readily available magnesium metal and lithium amide react together as the starting materials by the reaction of the formula (10) to remove the generated ammonia and hydrogen, then by introducing hydrogen into the system.

3Mg+8LiNH₂→4Li₂NH+Mg₃N₂+3H₂+2NH₃ (10)

Furthermore, the hydrogen storage material which absorbs and releases hydrogen in accordance with the reaction of the formula (6) can be prepared by bringing magnesium metal and lithium amide, and hydride of lithium or magnesium, or metal of lithium or magnesium, react together, then by introducing hydrogen into the system. As described above, by adding magnesium hydride and lithium amide, and hydride of lithium or magnesium, or metal of lithium or magnesium, to the system of the formula (10), the release of generated ammonia outside the system can be suppressed without affecting the composition of the target substance. As a result, the load to the industrial apparatuses is decreased to decrease the investment in the apparatuses, through which the synthesis can be conducted at an industrially advantageous position.

Similar to above, the hydrogen storage material which absorbs and releases hydrogen in accordance with the reaction of the formula (6) can be prepared by bringing readily available lithium metal and magnesium amide react together as the starting materials by the reaction of the formula (11) to remove the generated hydrogen, then by introducing hydrogen to the system.

3Mg(NH₂)₂+8Li→4Li₂NH+Mg₃N₂+4H₂ (11)

Furthermore, the hydrogen storage material which absorbs and releases hydrogen in accordance with the reaction of the formula (6) can be prepared by bringing lithium metal and magnesium amide, and hydride of lithium or magnesium, or metal of lithium or magnesium, react together, then by introducing hydrogen into the system. As described above, by adding magnesium hydride and lithium amide, and hydride of lithium or magnesium, or metal of lithium or magnesium, to the system of the formula (11), the release of generated ammonia outside the system can be suppressed without affecting the composition of the target substance. As a result, the load to the industrial apparatuses is decreased to decrease the investment in the apparatuses, through which the synthesis can be conducted at an industrially advantageous position.

For the case of a material prepared by using magnesium hydride (MgH₂) and lithium amide (LiNH₂), the mixing ratio of magnesium hydride is preferably in a range from 0.5 to 2 moles per 1 mole of lithium amide, and further preferably in a range from 0.5 to 1 mole thereof. For example, a combination of the formula (12) is adopted. The theoretical hydrogen storage percentage in accordance with the formula (12) is 7.08% by mass, which percentage is significantly improved from that in the case of the formula (5).

3MgH₂+4LiNH₂ [symbol] Mg₃N₂+2Li₂NH+6H₂ (12)

Although the reverse reaction to the formula (1) according to the Non-Patent Documents 1 and 2, or a hydrogen-release reaction, confirmed 9.3% by mass of hydrogen release percentage owing to the formation of lithium nitride, it is necessary for attaining that hydrogen release percentage to decompose the lithium imide into lithium nitride. Although the reaction gives high hydrogen release percentage, the value of AH is as large as −148 kJ/mole. The reaction therefore needs high temperatures and makes it difficult to bring the hydrogen release temperature to a low level.

The inventors of the present invention, however, found that the hydrogen release peak temperature can be lowered while maintaining the hydrogen release percentage at a relatively high level by combining lithium with magnesium which is easier to form a nitride than lithium does, and by combining them as in the formulae (6) and (12), thereby forming magnesium nitride and lithium imide.

That is, the formula (6) is supposedly accompanied with three steps of hydrogen release, as represented by the formulae (13), (14), and (15).

3Mg(NH₂)₂+3LiH→3MgNH+3LiNH₂+3H₂ (13)

3LiNH₂+3LiH→3Li₂NH+3H₂ (14)

3MgNH+2LiH→Mg₃N₂+Li₂NH+2H₂ (15)

The reduction of the hydrogen release temperature in the formula (6) is presumably caused by that the hydrogen release reaction (the formula (13)) of magnesium amide and lithium hydride begins at a significantly low temperatures depending on the combination of lithium amide and lithium hydride. In addition, it is presumed that the capability of maintaining a relatively high hydrogen release percentage in spite of low hydrogen release peak temperature in the hydrogen storage material according to the present invention owes to the easy progress of the reaction of the magnesium imide generated in the formula (13) down to the magnesium nitride as shown in the formula (15).

The mixture and the reaction product of metal hydride and metal amide compound are preferably structured and arranged at nano-scale by mechanical milling. The mechanical milling can be conducted by a planetary ball mill or the like for a small scale production. For the case of mass production, there can be adopted varieties of mixing and pulverizing methods disclosed by the inventors of the present invention in Japanese Patent Application No. 2004-36967: for example, roller mill, inner and outer cylinders rotary mill, ATOLITER, inner piece mill, and pneumatic pulverizing mill.

The mixing and pulverizing treatment for the metal amide compound with one or more compound or metal selected from the group consisting of a metal hydride, a metal nitride, a metal imide compound, and a metal to obtain the mixture and the reaction product of the metal hydride and the metal amide compound are conducted in an atmosphere of inert gas (for example, argon gas, nitrogen gas, and helium gas), hydrogen gas, or a mixture of inert gas and hydrogen gas. The environmental pressure (gas pressure) is preferably adjusted to atmospheric pressure or above. Under the condition, the amount of hydrogen released from the mixture and from the reaction product after the mixing and pulverizing treatment increases.

The mixture of metal amide compound with one or more compound or metal selected from the group consisting of a metal hydride, a metal nitride, a metal imide compound, and a metal, and the reaction product preferably contain a catalyst for enhancing the hydrogen absorbing and releasing performance. Preferred catalysts are one or more compounds or hydrogen storage alloy containing an element selected from the group containing B, C, Mn, Fe, Co, Ni, Pt, Pd, Rh, Na, Mg, K, Ir, Nb, Nd, La, Ca, V, Ti, Cr, Cu, Zn, Al, Si, Ru, Mo, Ta, Zr, Hf, and Ag, and more preferably one or more chloride, oxide, or metal containing an element selected from the group consisting of Nb, Nd, V, Ti, and Cr.

The supporting amount of such catalysts is preferably adjusted to a range from 0.1 to 20% by mass to the amount of the mixture of the metal amide compound and one or more compounds or metal selected from the group consisting of a metal hydride, a metal nitride, a metal imide compound, and a metal, and the reaction product. If the amount of supported catalyst is less than 0.1% by mass, the effect of enhancing the hydrogen-generation reaction cannot be attained. If the amount of supported catalyst exceeds 20% by mass, the reaction between the reactants such as metal hydride is hindered, or the hydrogen release percentage per unit mass decreases.

There are three applicable methods for supporting the catalytic substance for enhancing the hydrogen absorbing and releasing performance on the mixture of metal amide compound and one or more compounds or metal selected from the group consisting of a metal hydride, a metal nitride, a metal imide compound, and a metal, and the reaction product. The one is (a) adding the catalytic substance in the step of mixing and pulverizing the compound or the metal, thus bringing the catalytic substance to be supported on a treated material (the metal amide compound, one or more compounds or metal selected from the group consisting of a metal hydride, a metal nitride, a metal imide compound, and a metal, a mixture thereof, and a reaction product thereof). Another one is (b) mixing the treated material obtained by mixing and pulverizing the compound or the metal with the catalytic substance, thus bringing the catalytic substance to be supported on the treated material. Further one is (c) before mixing and pulverizing the compound or the metal, bringing the catalytic substance for enhancing the hydrogen absorbing and releasing performance to be supported on a metal amide compound, and one or more compounds or metal selected from the group consisting of a metal hydride, a metal nitride, a metal imide compound, and a metal, by mixing and pulverizing treatment or the like.

According to the present invention, the hydrogen storage material containing lithium and magnesium as the components can be manufactured by introducing hydrogen into the system after the heat treatment in a vacuum, which heat treatment is applied after the mixing step.

Alternatively, the hydrogen storage material containing lithium and magnesium as the components can be manufactured by applying heat treatment in an atmosphere of inert gas, hydrogen gas, or a mixture of inert gas and hydrogen gas, after the mixing and pulverizing step. Furthermore, by bringing the gas pressure to atmospheric pressure or above, the hydrogen storage material containing lithium and magnesium as the components can be manufactured.

In the present invention, lithium metal, lithium hydride, lithium amide, lithium imide, and lithium nitride can be used for the lithium component, and magnesium metal, magnesium hydride, magnesium amide, magnesium imide, and magnesium nitride can be used for the magnesium component. They can be combined for use adequately.

As an example, magnesium amide can be used for the metal amide compound, and lithium hydride, lithium metal, or lithium metal and magnesium metal can be used for one or more compounds or metal selected from the group consisting of a metal hydride, a metal nitride, a metal imide compound, and a metal. In addition, lithium amide can be used for the metal amide compound, and magnesium hydride, magnesium hydride and lithium hydride, magnesium metal, or magnesium metal and lithium metal can be used for one or more compound or metal selected from the group consisting of the metal hydride, the metal nitride, the metal imide compound, and the metal.

### EXAMPLES

The Examples and the Comparative Examples of the present invention will be described below.

(Preparation of Magnesium Amide)

Magnesium amide (Mg(NH₂)₂) was prepared by the following procedure. One gram of magnesium hydride (MgH₂) was put in a mill vessel made of high Cr steel, (250 ml of capacity), in a gloved box under a high purity argon atmosphere. The space in the mill vessel was evacuated. After introducing a specified amount of ammonia gas into the mill vessel to at or larger than the molar quantity of the formula (15), the vessel was sealed. Then, the mill vessel was subjected to milling at room temperature and under atmospheric pressure for a specified time under a condition of 250 rpm, thereby prepared the magnesium amide (Mg(NH₂)₂). The reacted gas in the mill vessel after the milling was analyzed to determine the amount of hydrogen and analyzed by XRD to confirm the formation of various metal amides. The raw materials used in the present invention are listed in Table 1.

MgH₂+2NH₃(g)→Mg(NH₂)₂+2H₂(g) (15)

### Examples 1 to 7

Table 2 shows the compositions of starting materials used in Examples 1 to 7 and Comparative Examples 1 and 2, which are described below. The respective raw materials selected from the group consisting of lithium hydride (LiH), magnesium hydride (MgH₂), lithium amide (LiNH₂), and magnesium amide (Mg(NH₂)₂) were weighed in a high purity argon gloved box so as the mixture to contain two kinds of metal elements and to give the composition shown in Table 2, and so as the amount of titanium trichloride (TiCl₃) to become 1.0% by mole to the total moles of the metal components in the starting materials, and then were charged in a mill vessel made of high Cr steel equipped with a valve. After evacuating the space in the mill vessel, high purity hydrogen gas was introduced into the mill vessel to 1 MPa. Then, the charged mixture in the mill vessel was subjected to milling in a planetary ball mill (P-5, manufactured by Fritsch GmbH) at room temperature and under atmospheric environment for 2 hours under a condition of 250 rpm. After evacuating the space in the mill vessel, and after filling the space with argon gas, the prepared sample in the mill vessel was taken out in the high purity argon gloved box.

### Example 8

In the above high purity argon gloved box, magnesium hydride (MgH₂) and lithium amide (LiNH₂) were weighed so as the mole ratio of them to become 3:8, and so as the total weight of them to become 1.3 g. They were subjected to milling in a similar procedure to that of Examples 1 to 7. After that, the prepared sample was transferred into a reactor with 30 cm³ of capacity in the high purity argon gloved box, which was then subjected to heat treatment in a vacuum at 250° C. and at 350° C. for 16 hours. Then, the sample was hydrogenated under a hydrogen pressure of 10 MPa at 200° C. for 12 hours.

### Example 9

Magnesium nitride (Mg₃N₂) and lithium amide (LiNH₂) were weighed so as the mole ratio of them to become 1:8 and so as the total weight of them to become 1.3 g. They were subjected to milling in a similar procedure to that of Examples 1 to 7. After that, the prepared sample was transferred into a reactor with 30 cm³ of capacity in the high purity argon gloved box, similar to Example 8, which sample was then subjected to heat treatment in a vacuum at 250° C. and at 350° C. for 16 hours. Then, the sample was hydrogenated under a hydrogen pressure of 10 MPa at 200° C. for 12 hours.

### Examples 10 to 17

Table 3 shows the compositions of starting materials used in Examples 10 to 17, which are described below. The respective raw materials selected from the group consisting of lithium metal (Li), lithium hydride (LiH), magnesium nitride (Mg₃N₂), magnesium hydride (MgH₂), lithium amide (LiNH₂), magnesium powder, and magnesium amide (Mg(NH₂)₂) were weighed in the high purity argon gloved box so as the mixture to contain two kinds of metal elements and to give the composition shown in Table 3 and so as the total amount of them to become 1.3 g. The mixture was subjected to milling. After that, the prepared sample was transferred into a reactor with 30 cm³ of capacity in the high purity argon gloved box, similar to Example 8, which sample was then subjected to heat treatment in a vacuum at 250° C. for 16 hours. Then, the sample was hydrogenated under a hydrogen pressure of 10 MPa at 200° C. for 12 hours.

### Example 18

In the above high purity argon gloved box, lithium nitride (Li₃N) and magnesium amide (Mg (NH₂)₂)) were weighed so as the mole ratio of them to become 8:9, and so as the total weight of them to become 1.3 g. The mixture was subjected to milling. After that, the prepared sample was transferred into a reactor with 30 cm³ of capacity in the high purity argon gloved box, similar to Example 8, which sample was then subjected to heat treatment in a vacuum at 350° C. for 16 hours. Then, the sample was hydrogenated under a hydrogen pressure of 10 MPa at 200° C. for 12 hours.

### Example 19

Lithium hydride (LiH), magnesium hydride (MgH₂), and lithium amide (LiNH₂) were weighed so as the mole ratio of them to become 2:3:6, and so as the total weight of them to become 1.3 g. The mixture was subjected to milling similar to Examples 1 to 7. After that, the prepared sample was transferred into a reactor with 30 cm³ of capacity in the high purity argon gloved box, similar to Example 8, which sample was then subjected to heat treatment in a vacuum at 200° C. for 16 hours. Then, the sample was subjected to heat treatment under a hydrogen pressure of 10 MPa at 200° C. for 12 hours.

### Example 20

Magnesium nitride (Mg₃N₂) and lithium amide (LiNH₂) were weighed so as the mole ratio of them to become 1:8 and so as the total weight of them to become 1.3 g. The mixture was subjected to milling similar to Examples 1 to 7. After that, the prepared sample was transferred into a reactor with 30 cm³ of capacity in the high purity argon gloved box, similar to Example 8, which sample was then subjected to heat treatment under a hydrogen pressure of 10 MPa at 200° C. for 12 hours.

### Examples 21 to 26

Magnesium hydride (MgH₂) and lithium amide (LiNH₂) were weighed so as the mole ratio of them to become 3:8, and so as the total weight of them to become 1.3 g. A catalyst was selected from the group consisting of Nb₂O₅, TiO₂, TiCl₃, CrCl₃, VCl₃, and VCl₂. The selected catalyst was added to the starting material by an amount so as the metal component in the catalyst to become 1.0% by mole to the total moles of the metal components in the starting material. Thus prepared mixture was subjected to milling similar to Examples 1 to 7. After that, the prepared sample was transferred into a reactor with 30 cm³ of capacity in the high purity argon gloved box, similar to Example 8, which sample was then subjected to heat treatment in a vacuum at 350° C. for 16 hours. Then, the sample was subjected to heat treatment under a hydrogen pressure of 10 MPa at 200° C. for 12 hours.

### Comparative Examples 1 and 2

In Comparative Examples 1 and 2, the mixture was prepared so as metal hydride and metal amide compound to contain one kind of metal. In Comparative Example 1, lithium hydride (LiH) and lithium amide (LiNH₂), and in Comparative Example 2, magnesium hydride (MgH₂) and magnesium amide (Mg(NH₂)₂), were weighed in a high purity argon gloved box to give specified compositions given in Table 2, respectively, while the amount of titanium trichloride (TiCl₃) becomes 1.0% by mole to the total moles of the metal components in the starting material. Each mixture was charged into a mill vessel made of high Cr steel equipped with a valve. After evacuating the space in the mill vessel, high purity hydrogen gas was introduced into the mill vessel to 1 MPa. Then, the mill vessel was subjected to milling in a planetary ball mill at room temperature and under atmospheric environment for 2 hours under a condition of 250 rpm. After evacuating the space in the mill vessel, and after filling the space with argon gas, the sample in the mill vessel was taken out in a high purity argon gloved box.

(Sample Evaluation)

Each of thus prepared samples was put in a TG-MASS apparatus (thermogravimetric mass spectrometer) placed in a high purity argon gloved box. The apparatus was heated at a temperature-rise speed of 5° C./min, and the desorbed gas was sampled for analysis. For some samples, evaluation was given by X-ray diffraction method at room temperature while avoiding exposure to moisture and oxygen in air.

(Result)

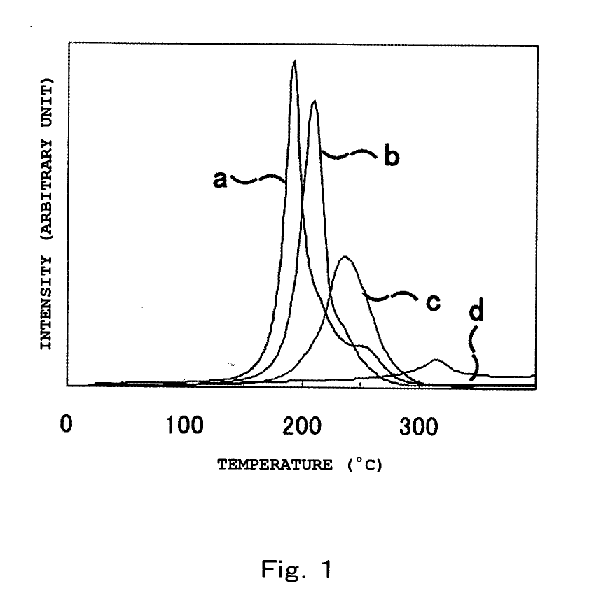

FIG. 1 shows the release spectra of desorbed hydrogen gas during temperature rise, observed by TG-MASS apparatus, or the relation between the temperature and the hydrogen release intensity. The characteristic line “a” in FIG. 1 represents Example 1, the characteristic line “b” represents Example 2, the characteristic line “c” represents Comparative Example 1, and the characteristic line “d” represents Comparative Example 2. Table 2 also shows the peak temperature (° C.) in the hydrogen gas release spectrum curve for each sample, (hereinafter referred to as the “hydrogen release peak temperature”).

FIG. 1 shows that the hydrogen release peak temperature of Example 1 is 192° C., and that of Example 2 is 209° C. The hydrogen release peak temperatures of Examples 1 and 2 are confirmed to become lower than that of Comparative Example 1, 239° C., and Comparative Example 2, 317° C. As seen in Table 2, it is confirmed that the hydrogen release peak temperature in each of Examples 3 to 7 becomes lower than that of Comparative Example 1.

For the cases of Examples 1 to 5, where the mole ratio of lithium hydride to magnesium amide is in a range from 1.5 to 4, the hydrogen release peak temperature becomes low, and for the cases of Examples 1 and 3, where the mole ratio of lithium hydride to magnesium amide is in a range from 2.5 to 3.5, the hydrogen release temperature becomes further low.

Table 3 shows that the hydrogen release peak temperatures in Examples 8 to 20 become lower than those in Comparative Examples 1 and 2, shown in Table 2.

Table 4 shows that the hydrogen release peak temperatures in Examples 21 to 26 become lower than those in Comparative Examples 1 and 2, shown in Table 2, and that of Example 8 shown in Table 3.

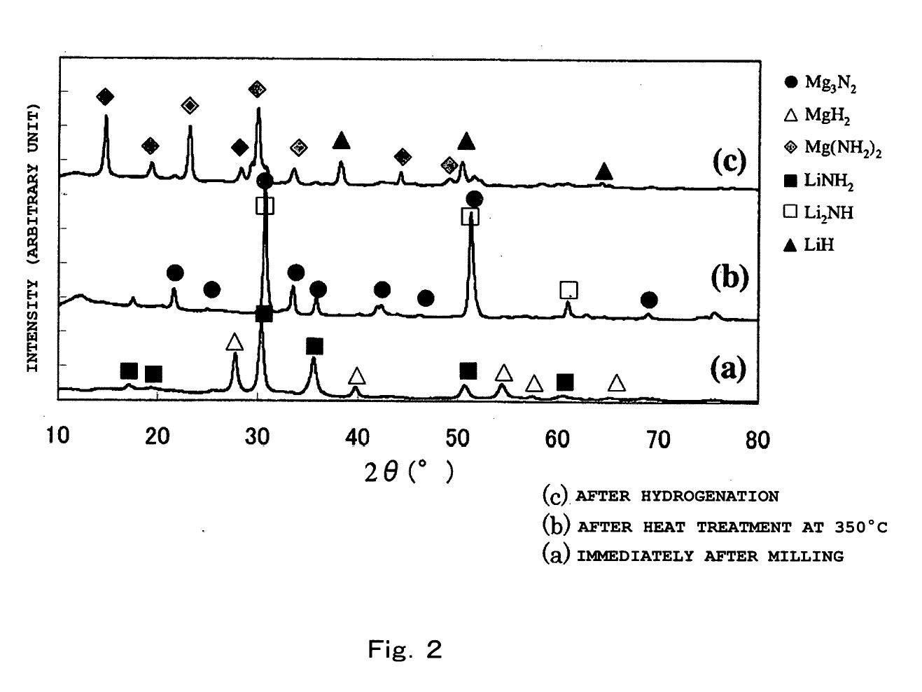

FIG. 2 shows the XRD patterns in Example 9, as an example, at immediately after milling (XRD profile “a”), after heat treatment at 350° C. in a vacuum (XRD profile “b”), and after hydrogenation (XRD profile “c”).

It is shown that, at the point of immediately after milling, the peaks are for lithium amide (LiNH₂) and magnesium hydride (MgH₂) in the raw material. On the other hand, the XRD pattern after hydrogenation shows that both magnesium amid (Mg(NH₂)₂) and lithium hydride (LiH) are practically synthesized after the hydrogenation.

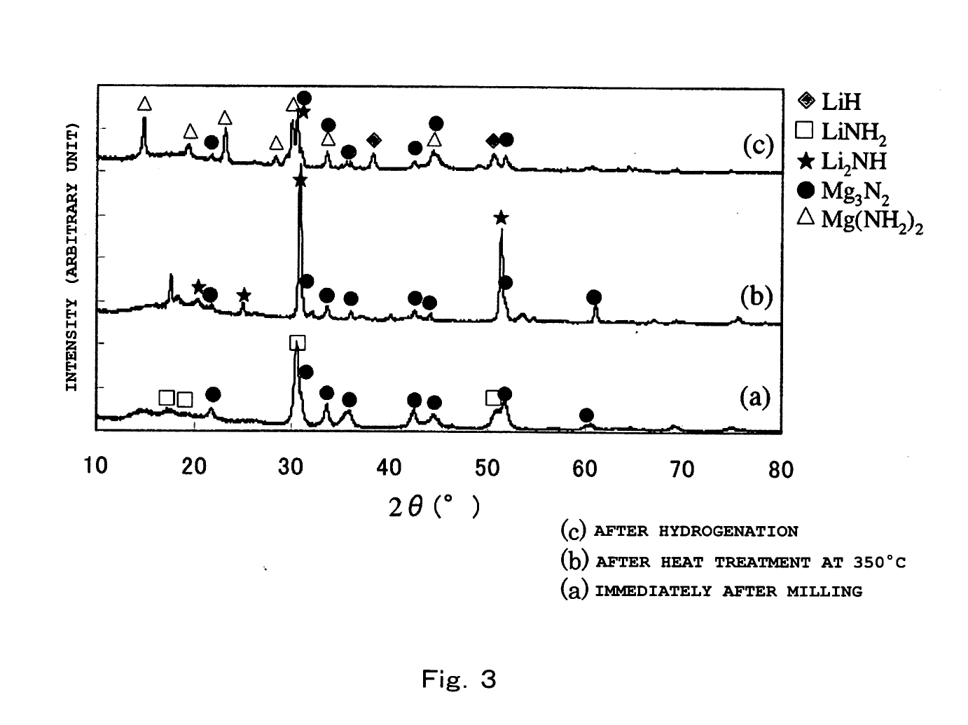

FIG. 3 shows the XRD patterns in Example 11, obtained by an X-ray diffractometer, at immediately after milling (XRD profile “a”), after heat treatment at 350° C. in a vacuum (XRD profile “b”), and after hydrogenation (XRD profile “c”).

It is shown that, at the point of immediately after milling, the peaks are for lithium amide (LiNH₂) and magnesium nitride (Mg₃N₂) in the raw material. The XRD pattern after hydrogenation shows that magnesium amide (Mg(NH₂)₂) and lithium hydride (LiH) are practically synthesized, though trace amount of magnesium nitride in the raw material and of lithium imide (Li₂NH) generated during heat treatment are detected.

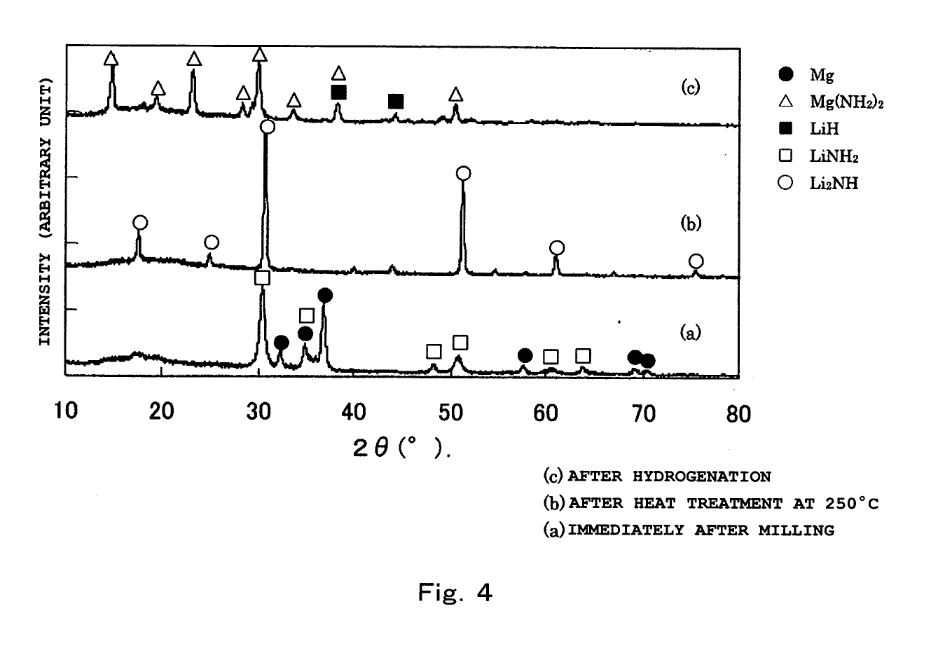

FIG. 4 shows the XRD patterns in Example 14, obtained by the X-ray diffractometer, at immediately after milling (XRD profile “a”), after heat treatment at 250° C. in a vacuum (XRD profile “b”), and after hydrogenation (XRD profile “c”).

It is shown that, at the point of immediately after milling, the peaks are for lithium amide (LiNH₂) and magnesium metal (Mg) in the raw material. After the heat treatment, the peak of meal magnesium disappeared. The XRD pattern after hydrogenation shows that magnesium amide (Mg(NH₂)₂) and lithium hydride (LiH) are practically synthesized.

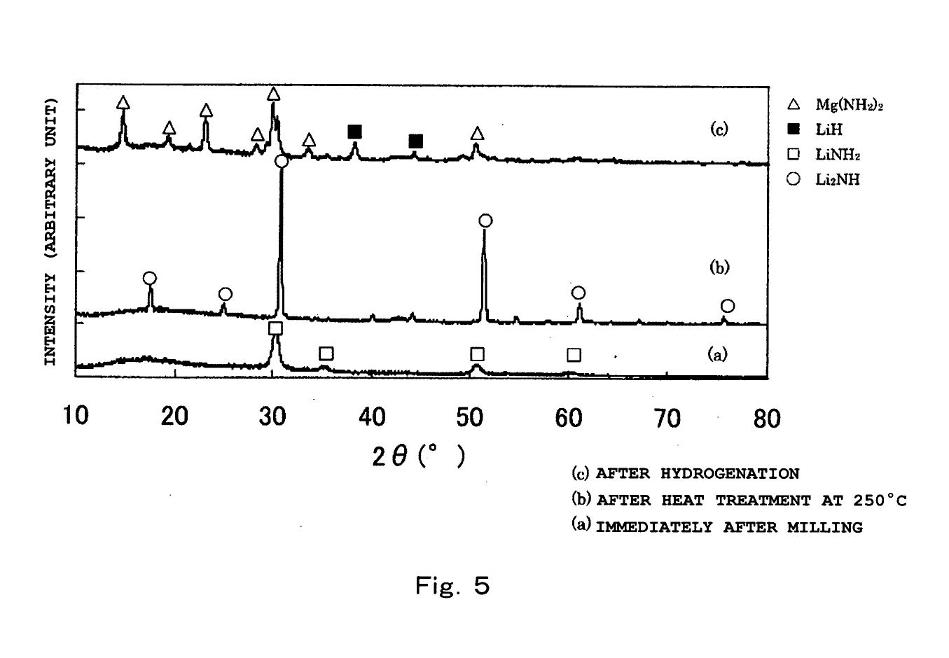

FIG. 5 shows the XRD patterns in Example 17, obtained by the X-ray diffractometer, at immediately after milling (XRD profile “a”), after heat treatment at 250° C. in a vacuum (XRD profile “b”), and after hydrogenation (XRD profile “c”).

At immediately after milling, lithium amide (LiNH₂) in the raw material is confirmed. For magnesium amide (Mg (NH₂)₂) as the raw material, however, the compound is not confirmed because it is in an amorphous state owing to the milling given in the preparation step. The XRD pattern after hydrogenation shows that magnesium amide (Mg(NH₂)₂) and lithium hydride (LiH) are practically synthesized.

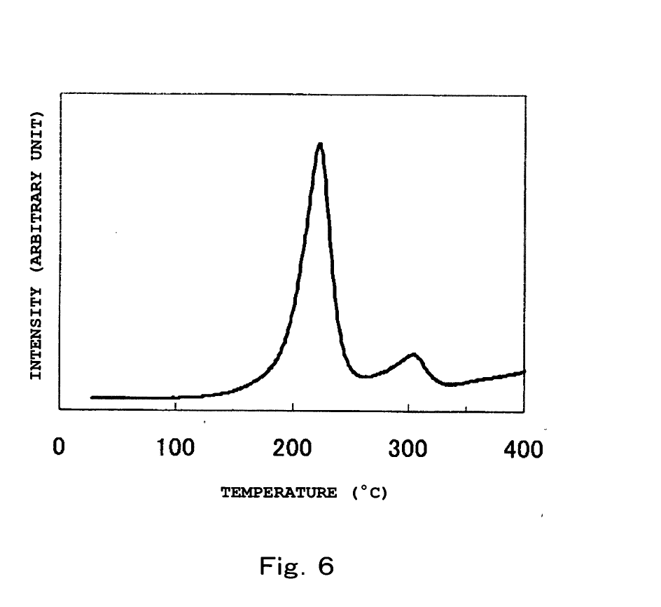

FIG. 6 shows a release spectrum of desorbed hydrogen gas of Example 20, observed in a TG-MASS apparatus during temperature rise step. The figure shows that the hydrogen release peak temperature is 223° C.

### Examples 27 to 31

Table 5 shows the compositions of starting materials used in Examples 27 to 31, which are described below. Magnesium hydride (MgH₂) and lithium amide (LiNH₂) were weighed in a high purity argon gloved box so as the composition to become the respective ones given in Table 5, and so as the amount of titanium trichloride (TiCl₃) to become 1.0% by mole to the total moles of the metal components in the starting materials, and then each mixture was charged in a mill vessel made of high Cr steel equipped with a valve. After evacuating the space in the mill vessel, high purity hydrogen gas was introduced into the mill vessel to 1 MPa. Then, the mill vessel was subjected to milling in a planetary ball mill (P-5, manufactured by Fritsch GmbH) at room temperature and under atmospheric environment for 2 hours under a condition of 250 rpm. After evacuating the space in the mill vessel, and after filling the space with argon gas, the prepared sample in the mill vessel was taken out in a high purity argon gloved box.

As shown in Table 5, the hydrogen release peak temperatures also in Examples 27 to 31 which used magnesium hydride and lithium amide become lower than those of Comparative Examples 1 and 2. For Examples 27 to 30 where the mole ratio of magnesium hydride to lithium amide is in a range from 0.5 to 2.0, the hydrogen release peak temperature becomes further low. For Examples 27 to 29 where the mole ratio of magnesium hydride to lithium amide is in a range from 0.5 to 1.0, the effect of lowering the peak temperature becomes significant.

TABLE 1

| Name of raw material | Purity | |
|---|---|---|
| (chemical formula) | (%) | Manufacturer, agent |
| Magnesium hydride (MgH₂) | 95 | Trade agent: AZmax Co., Ltd. |
| Lithium hydride (LiH) | 95 | Manufacturer: |
| | | Sigma-Aldrich Corporation |
| Lithium amide (LiNH₂) | 95 | Manufacturer: |
| | | Sigma-Aldrich Corporation |
| Titanium trichloride | 99.999 | Manufacturer: |
| (TiCl₃) | | Sigma-Aldrich Corporation |
| Magnesium nitride (Mg₃N₂) | 99.5 | Manufacturer: |
| | | Sigma-Aldrich Corporation |
| Magnesium (Mg) | 99.9 | Manufacturer: |
| | | Japan Pure Chemical Co., Ltd. |
| Lithium (Li) | 99.9 | Manufacturer: |
| | | Sigma-Aldrich Corporation |
| Vanadium chloride (VCl₂) | 95 | Manufacturer: |
| | | Sigma-Aldrich Corporation |
| Vanadium chloride (VCl₃) | — | Manufacturer: |
| | | Sigma-Aldrich Corporation |
| Chromium chloride (CrCl₃) | 99.99 | Manufacturer: |
| | | Sigma-Aldrich Corporation |
| Titanium oxide (TiO₂) | 99.9 | Manufacturer: |
| | | Sigma-Aldrich Corporation |
| Magnesium nitride (Nb₂O₅) | 99.9 | Manufacturer: |
| | | Sigma-Aldrich Corporation |

TABLE 2

| | | | | | | Hydrogen |
|---|---|---|---|---|---|---|
| | | Mixing ratio in raw material | | | | release peak |
| | LiH/Mg(NH₂)₂ | (mole ratio) | | | | temperature |
| | mole ratio | LiH | Mg(NH₂)₂ | MgH₂ | LiNH₂ | (° C.) |
| Example 1 | 2.7 | 8 | 3 | 0 | 0 | 192 |
| Example 2 | 2.0 | 2 | 1 | 0 | 0 | 209 |
| Example 3 | 3.0 | 3 | 1 | 0 | 0 | 199 |
| Example 4 | 4.0 | 4 | 1 | 0 | 0 | 215 |
| Example 5 | 1.5 | 1.5 | 1 | 0 | 0 | 220 |
| Example 6 | 1.0 | 1 | 1 | 0 | 0 | 225 |
| Example 7 | 5.0 | 5 | 1 | 0 | 0 | 226 |
| Comparative | — | 1 | 0 | 0 | 1 | 240 |
| Example 1 | | | | | | |
| Comparative | — | 0 | 1 | 1 | 0 | 317 |
| Example 2 | | | | | | |

TABLE 3

| | | | | | | | | | Heat | |
|---|---|---|---|---|---|---|---|---|---|---|
| | | | | | | | | | treatment | Peak |
| | Mixing ratio in raw material (mole ratio) | | | | | | | | temperature | temperature |
| | Li | LiH | Li₃N | Mg₃N₂ | MgH₂ | Mg | Mg(NH₂)₂ | LiNH₂ | (° C.) | (° C.) |
| Example 8 | 0 | 0 | 0 | 0 | 3 | 0 | 0 | 8 | 250 | 230 |
| Example 9 | 0 | 0 | 0 | 0 | 3 | 0 | 0 | 8 | 350 | 230 |
| Example 10 | 0 | 0 | 0 | 1 | 0 | 0 | 0 | 8 | 250 | 230 |
| Example 11 | 0 | 0 | 0 | 1 | 0 | 0 | 0 | 8 | 350 | 230 |
| Example 12 | 0 | 2 | 0 | 0 | 3 | 0 | 0 | 6 | 250 | 232 |
| Example 13 | 0 | 4 | 0 | 1 | 0 | 0 | 0 | 4 | 250 | 233 |
| Example 14 | 0 | 0 | 0 | 0 | 0 | 3 | 0 | 8 | 250 | 233 |
| Example 15 | 2 | 0 | 0 | 0 | 0 | 3 | 0 | 6 | 250 | 230 |
| Example 16 | 8 | 0 | 0 | 0 | 0 | 0 | 3 | 0 | 250 | 232 |
| Example 17 | 0 | 0 | 0 | 0 | 0 | 0 | 3 | 8 | 250 | 232 |
| Example 18 | 0 | 0 | 8 | 0 | 0 | 0 | 9 | 0 | 350 | 233 |
| Example 19 | 0 | 2 | 0 | 0 | 3 | 0 | 0 | 6 | 200 | 219 |
| Example 20 | 0 | 0 | 0 | 1 | 0 | 0 | 0 | 8 | 200 | 223 |

TABLE 4

| | Mixing ratio | | | |
|---|---|---|---|---|
| | in raw material | | | Peak |
| | (mole ratio) | | Catalyst | temperature |
| | MgH₂ | LiNH₂ | species | (° C.) |
| Example 21 | 3 | 8 | Nb₂O₅ | 221 |
| Example 22 | 3 | 8 | TiO₂ | 221 |
| Example 23 | 3 | 8 | TiCl₃ | 223 |
| Example 24 | 3 | 8 | CrCl₃ | 227 |
| Example 25 | 3 | 8 | VCl₃ | 214 |
| Example 26 | 3 | 8 | VCl₂ | 216 |

TABLE 5

| | | Mixing ratio | | |
|---|---|---|---|---|
| | | in raw material | | Peak |
| | MgH₂/LiNH₂ | (mole ratio) | | temperature |
| | mole ratio | MgH₂ | LiNH₂ | (° C.) |
| Example 27 | 0.75 | 3 | 4 | 213 |
| Example 28 | 0.5 | 1 | 2 | 221 |
| Example 29 | 1.0 | 1 | 1 | 225 |
| Example 30 | 2.0 | 2 | 1 | 228 |
| Example 31 | 3.0 | 3 | 1 | 235 |

### INDUSTRIAL APPLICABILITY

The hydrogen storage material and the manufacturing method thereof according to the present invention are suitable for fuel cell and the like for generating power using hydrogen and oxygen as the fuels, and also suitable for the operation thereof.

1. A hydrogen storage material comprising a mixture and a reaction product of lithium hydride and magnesium amide, which is prepared by combining one or more substance selected from the group consisting of an imide compound and a nitride of magnesium, and an amide compound, an imide compound and a nitride of lithium; and one or more substance selected from the group consisting of a metal of magnesium, and a hydride and a metal of lithium as the raw materials, with the raw materials containing both the magnesium and lithium metallic species.

2. A hydrogen storage material comprising a mixture and a reaction product of lithium hydride and magnesium amide, which is prepared by using magnesium nitride and lithium amide as the raw materials.

3. A hydrogen storage material comprising a mixture and a reaction product of lithium hydride and magnesium amide, which is prepared by using magnesium metal and lithium amide as the raw materials, and further using one or more substance selected from the group consisting of lithium hydride and magnesium hydride as the raw materials.

4. A hydrogen storage material comprising: a mixture and a reaction product of lithium hydride and magnesium amide, which is prepared by using lithium metal and magnesium metal as the raw materials, and further using one or more substance selected from the group consisting of lithium amide and magnesium amide as the raw materials.

5. The hydrogen storage material according to claim 1, wherein the mixing ratio of lithium hydride is in a range from 1.5 to 4 moles per 1 mole of magnesium amide.

6. The hydrogen storage material according to claim 1, further comprising a catalyst for enhancing hydrogen absorbing and releasing performance.

7. The hydrogen storage material according to claim 6, wherein said catalyst for enhancing hydrogen absorbing and releasing performance is one or more compound or hydrogen storage alloy, containing an element selected from the group consisting of B, C, Mn, Fe, Co, Ni, Pt, Pd, Rh, Na, Mg, K, Ir, Nb, Nd, La, Ca, V, Ti, Cr, Cu, Zn, Al, Si, Ru, Mo, Ta, Zr, Hf, and Ag.

8. The hydrogen storage material according to claim 7, wherein said catalyst for enhancing hydrogen absorbing and releasing performance is one or more chloride, oxide, or metal, containing an element selected from the group consisting of Nb, Nd, V, Ti, and Cr.

9. The hydrogen storage material according to claim 1, wherein said mixture and reaction product are structured and arranged at nano-scale by mechanical milling.

10. A method for manufacturing hydrogen storage material containing metal of lithium and metal of magnesium as the components, comprising the mixing step of mixing a metal amide compound with one or more compound or metal selected from the group consisting of a metal imide compound, and a metal, to react in an atmosphere of inert gas, hydrogen gas, or a mixture of inert gas and hydrogen gas.

11. A method for manufacturing hydrogen storage material containing metal of lithium and metal of magnesium as the components, comprising the steps of: mixing a metal amide compound with one or more compound or metal selected from the group consisting of a metal nitride, a metal imide compound and a metal, to react in an atmosphere of inert gas, hydrogen gas, or a mixture of inert gas and hydrogen gas; supporting a catalyst through any of catalyst-supporting steps of: further adding a catalytic substance for enhancing hydrogen absorbing and releasing performance in said mixing step, thus supporting said catalytic substance on a treated material; mixing a catalytic substance for enhancing hydrogen absorbing and releasing performance with the treated material obtained by said mixing step, thus supporting said catalytic substance on said treated material; and supporting a catalytic substance for enhancing hydrogen absorbing and releasing performance on at least one of said metal hydride and metal amide compound before said mixing step.

12. The method for manufacturing hydrogen storage material according to claim 11, wherein said catalytic substance is one or more compound or hydrogen storage alloy containing an element selected from the group consisting of B, C, Mn, Fe, Co, Ni, Pt, Pd, Rh, Na, Mg, K, Ir, Nb, Nd, La, Ca, V, Ti, Cr, Cu, Zn, Al, Si, Ru, Mo, Ta, Zr, Hf, and Ag.

13. The method for manufacturing hydrogen storage material according to claim 11, wherein said catalytic substance is one or more chloride, oxide, or metal containing an element selected from the group consisting of Nb, Nd, V, Ti, and Cr.

14. A method for manufacturing hydrogen storage material containing metal of lithium and metal of magnesium as the components, comprising a step of mixing lithium amide with magnesium nitride to react in an atmosphere of inert gas, hydrogen gas, or a mixture of inert gas and hydrogen gas.

15. A method for manufacturing hydrogen storage material containing metal of lithium and metal of magnesium as the components, comprising a step of mixing lithium amide, magnesium nitride and one or more compound selected from the group consisting of lithium hydride and magnesium hydride to react in an atmosphere of inert gas, hydrogen gas, or a mixture of inert gas and hydrogen gas.

16. A method for manufacturing hydrogen storage material containing metal of lithium and metal of magnesium as the components, comprising a step of mixing lithium amide with magnesium metal to react in an atmosphere of inert gas, hydrogen gas, or a mixture of inert gas and hydrogen gas.

17. A method for manufacturing hydrogen storage material containing metal of lithium and metal of magnesium as the components, comprising a step of mixing lithium amide, magnesium metal and one or more compound selected from the group consisting of lithium hydride and magnesium hydride to react in an atmosphere of inert gas, hydrogen gas, or a mixture of inert gas and hydrogen gas.

18. A method for manufacturing hydrogen storage material containing metal of lithium and metal of magnesium as the components, comprising a step of mixing lithium amide, magnesium metal, lithium metal and one or more compound selected from the group consisting of lithium hydride and magnesium hydride to react in an atmosphere of inert gas, hydrogen gas, or a mixture of inert gas and hydrogen gas.

19. The method for manufacturing hydrogen storage material according to claim 10, wherein the gas pressure in said mixing step is atmospheric pressure or above.

20. The method for manufacturing hydrogen storage material according to claim 10, said mixing step is followed by the step of heat treatment given in a vacuum.

21. The method for manufacturing hydrogen storage material according to claim 10, wherein said mixing step is followed by the step of heat treatment in an atmosphere of inert gas, hydrogen gas, or a mixture of inert gas and hydrogen gas.

22. The hydrogen storage material according to claim 4, wherein the mixing ratio of lithium hydride is in a range from 1.5 to 4 moles per 1 mole of magnesium amide.

23. The hydrogen storage material according to claim 4, further comprising a catalyst for enhancing hydrogen absorbing and releasing performance.

24. The hydrogen storage material according to claim 4, wherein said mixture and reaction product are structured and arranged at nano-scale by mechanical milling.

25. The method for manufacturing hydrogen storage material according to claim 14, wherein the gas pressure in said mixing step is atmospheric pressure or above.

26. The method for manufacturing hydrogen storage material according to claim 14, said mixing step is followed by the step of heat treatment given in a vacuum.

27. The method for manufacturing hydrogen storage material according to claim 14, wherein said mixing step is followed by the step of heat treatment in an atmosphere of inert gas, hydrogen gas, or a mixture of inert gas and hydrogen gas.

28. The method for manufacturing hydrogen storage material according to claim 16, wherein the gas pressure in said mixing step is atmospheric pressure or above.

29. The method for manufacturing hydrogen storage material according to claim 16, said mixing step is followed by the step of heat treatment given in a vacuum.

30. The method for manufacturing hydrogen storage material according to claim 16, wherein said mixing step is followed by the step of heat treatment in an atmosphere of inert gas, hydrogen gas, or a mixture of inert gas and hydrogen gas.
